(19) United States
(12) Patent Application Publication
(10) Pub. No.: US 2022/0380512 A1
(43) Pub. Date: Dec. 1, 2022

(54) STORAGE-STABLE THERMOLATENT CATALYSTS FOR THE POLYMERIZATION OF ISOCYANATES

(71) Applicant: COVESTRO INTELLECTUAL PROPERTY GMBH & CO. KG, Leverkusen (DE)

(72) Inventors: Piet Driest, Amersfoort (NL); Dirk Achten, Leverkusen (DE); Richard Meisenheimer, Köln (DE); Denise Kleinschmidt, Aachen (DE)

(21) Appl. No.: 17/762,187

(22) PCT Filed: Oct. 2, 2020
(86) PCT No.: PCT/EP2020/077758

§ 371 Date: Mar. 21, 2022

(30) Foreign Application Priority Data
Oct. 7, 2019 (EP) 19201636.8

(51) Int. Cl. C08G 18/02; C08G 18/79; C08G 18/22; C08G 18/24; C08G 18/73; C08G 18/75; C08G 18/76

(52) U.S. Cl. CPC C08G 18/02; C08G 18/792; C08G 18/222; C08G 18/24; C08G 18/225; C08G 18/73; C08G 18/755; C08G 18/7621; C08G 18/7692

(57) ABSTRACT

The present invention relates to the use of metal salts of polymeric alcohols as storage-stable thermolatent catalysts for the manufacture of isocyanurate and polyisocyanate polymers.

The present invention relates to the use of metal salts of polymeric alcohols as storage-stable thermolatent catalysts for the manufacture of isocyanurate and polyisocyanate polymers.

DE 10 2004 048775 discloses urethanization catalysts which do not comprise catalytically active polymeric alcoholates but teaches the use of polymeric alcohols as building blocks to form polyurethanes from isofunctional uretdions. As these compounds lack an alkoxide function, they cannot form metal salts of polymeric alcohols as understood by the present application to catalyze a trimerization reaction.

Polyisocyanurate plastics and the use of potassium acetate as catalyst in their production are known, e.g., from WO 2016/170059. Composite materials with a polyisocyanurate matrix have been disclosed in WO 2017/191216. A mixture of polyethylene glycol with a number-average molecular weight of 400 g/mol and potassium ions was used as catalyst. The pot life of the polymerizable composition was in the range of five hours at a temperature of 23° C. The system was not stable for several days when employed with typical catalyst loads as described

The combination potassium acetate with polyethylene glycol as catalyst has a low pot life at elevated temperatures of up to 50° C., particularly if the air moisture is high. Such conditions are frequently encountered in workshops in tropical climates. Under these conditions the viscosity of the reaction mixture may increase by a factor of 10 or more after only one hour. Moreover, foam formation on the surface of the reaction mixture is a frequent problem. These effects combined render such a reaction mixture impractical for applications such as in an open bath for pultrusion or filament winding processes.

One well known technique for producing latent catalysts is the encapsulation of a liquid catalyst in a solid shell in order to isolate it from the reactants. For trimerization catalysts based on alkali metal salts this has been disclosed in U.S. Pat. No. 3,860,565. The encapsulated catalyst can easily be activated by exposure to various kinds of energy (radiation, heat, mechanical forces) which may result in an unwanted activation during the preparation of the catalyst or processing of the reactive composition.

Therefore, the problem underlying the present invention is the provision of a non-encapsulated catalyst for the crosslinking of isocyanate groups with a long pot life at temperatures up to 50° C. and a high reactivity above that temperature. Said catalyst should not be hygroscopic and should not promote foaming of an isocyanate composition. Furthermore, the catalyst should be easily obtained and readily used without sophisticated processing to ensure broad industrial use. The problem is solved by the embodiments defined by the claims and in this description below.

In the study underlying the present invention it was surprisingly found that a catalyst does not need to be encapsulated in order to sufficiently decrease its activity at temperatures up to 50° C. If a metal ion such as the potassium ion is present as the counterion of an alcoholate of a polymeric alcohol the resulting catalyst composition shows low reactivity at ambient temperatures even though alcoholates are well known to those skilled in the art for their high reactivity in catalyzing isocyanate reactions. Therefore, in a first embodiment the present invention relates to the use of a metal salt of a polymeric alcohol as a catalyst for the polymerization of polyisocyanates.

Said use preferably involves the heating of a mixture comprising the metal salt of a polymeric alcohol and at least one polyisocyanate to a temperature which is sufficient to induce the polymerization of polyisocyanates. According to the present invention this is a temperature of at least 60° C., preferably at least 75° C. and most preferably at least 90° C. In order to avoid the decomposition of the polymer or its components the temperature should not exceed 400° C. during the polymerization reaction.

### Metal Salt of a Polymeric Alcohol

The term “metal salt of a polymeric alcohol” relates to a salt whose anion is the alcoholate ion (in the art also commonly referred to as alkoxide) of the polymeric alcohol and whose cation is a metal ion.

### Metal Ion

Suitable metal ions are (half)-metal ions with an oxidation state of IV or less, preferably II or less. Said (half)-metal ions preferably belong to the group of alkali and alkaline earth metals, as well as metal ions of the 3-12 side group of the periodic table.

Preferred are ions of tin, particularly tin(IV), aluminium, manganese, iron, cobalt, nickel, copper, zinc, zirconium, cerium or lead, alkaline metals and alkaline earth metals. More preferred are ions of tin, alkaline or alkaline earth metals. Even more preferably, the metal ion is selected from the group consisting of tin, potassium, lithium, sodium, calcium, magnesium. Most preferably, the metal ion is selected from the group consisting of tin, particularly tin(IV), aluminium, magnesium and potassium. A particularly preferred metal ion is potassium.

### Polymeric Alcohol

The term “polymeric alcohol” as used in the claims may refer to a single compound or to a mixture of two or more different polymeric alcohols.

The polymeric alcohol is selected from the group consisting of polyether alcohols polyester alcohols and polycarbonate diols. Preferably, the polymeric alcohol is a polyether alcohol or a mixture of at least two polyether alcohols.

Preferred polyether alcohols are based on the polyaddition of ethylene oxide, propylene oxide, tetrahydrofuran or mixtures of the aforementioned monomers. Starter molecules for the polyaddition may be water or any type of alcohol. Preferably, the polymeric alcohol has a number-average molecular weight between 400 g/mol and 22,000 g/mol, more preferably 600 g/mol to 12,000 g/mol and most preferably 1,000 g/mol to 10,000 g/mol.

Particularly preferred polyether alcohols are polyethylene glycol, polypropylene glycol and polytetrahydrofuran. Polyethylene glycol has, preferably, a number-average molecular weight between 400 g/mol and 10,000 g/mol. Polypropylene glycol has, preferably, a number-average molecular weight between 1,200 g/mol and 4,000 g/mol. Polytetrahydrofuran has, preferably, a number-average molecular weight between 650 g/mol and 2,000 g/mol.

Preferred polyester polyols are reaction products of phthalic acid, phthalic acid anhydride or symmetric α, ω-C₄ to C₁₀ carboxylic acids with one or more C₂ to C₁₀ diols. Preferably they have a number average molecular weight between 500 and 40,000 g/mol. Especially suitable diols are monoethylene glycol, 1,4-butane diol, 1,6-hexane diol and neopentyl glycol.

Particularly preferred polyester alcohols are polycaprolactones as well as esters of adipic, malonic, phthalic and fumaric acid containing butandiol and/or hexandiol, preferably with a number average molecular weight between 500 and 40,000 g/mol.

In order to obtain the alcololate ions of the polymeric alcohols defined above any method known in the art may be used. It is preferred to react the polymeric alcohol with a strong base. Said base is, preferably tert-butoxide. In order to combine the alcoholate of the polymeric alcohol with the desired metal ion as counterion it is preferred to use tert-butoxide with said metal ion as counterion for the reaction with the polymeric alcohol.

In order to realize the advantages of the present invention it is not necessary to convert all hydroxyl groups of the polymeric alcohol to alcoholate groups. It is sufficient if at least 5%, preferably at least 10%, more preferably at least 20%, even more preferably at least 50% and most preferably at least 80% of the hydroxyl groups present in the polymeric alcohol are deprotonated to alcoholate groups.

In a preferred embodiment of the present invention the metal salt of the polymeric alcohol has a Tg not more than 50° C. It is particularly preferred that it has a melting point between 25° C. and 160° C., more preferably 30° C. to 120° C. and most preferably 40° C. to 100° C.

### Polymerization of Polyisocyanates

The term “polymerization of polyisocyanates” refers to any chemical reaction which links two or more isocyanate groups comprised by different polyisocyanate molecules with each other. In this context, the term “different polyisocyanate molecules” does not refer to two species of polyisocyanates having different chemical structures. It merely refers to two or more separate polyisocyanate molecules. Said separate polyisocyanate molecules may have an identical or a different chemical structure.

Thus, the polymerization of polyisocyanates preferably leads to a new compound comprising at least one type of structure selected from group consisting of uretdione, isocyanurate, iminooxadiazinedione and oxadiazinetrione structures. More preferably, the compound formed by the above-defined “polymerization of polyisocyanates” comprises isocyanurate structures.

Moreover, during the “polymerization of polyisocyanates” at least 70%, preferably at least 80%, more preferably at least 90% and most preferably at least 95% of the free isocyanate groups originally present in the polyisocyanates are consumed. The result of this process is a polymer network.

In a preferred embodiment of the present invention during the “polymerization of isocyanates” at least 50% of the isocyanate groups are consumed in the process of polymerization and form isocyanurate structures.

The polymeric material derives its advantageous properties from the reaction of isocyanate groups with each other. Thus, the formation of addition products of an isocyanate group and hydroxyl, thiol and amino groups is not desired as a main reaction. Therefore, in a preferred embodiment of the present invention the polymerization of polyisocyanates refers to a process, wherein less than 30%, preferably less than 20% and most preferably less than 10% of the isocyanate groups originally present in the polyisocyanate react with hydroxyl, thiol and amino groups.

### Polyisocyanate

The term “polyisocyanate” as used here is a collective term for compounds containing two or more isocyanate groups in the molecule (this is understood by the person skilled in the art to mean free isocyanate groups of the general structure —N═C═O). The simplest and most important representatives of these polyisocyanates are the diisocyanates. These have the general structure O═C═N—R—N═C═O where R typically represents aliphatic, alicyclic and/or aromatic radicals.

Because of the polyfunctionality (≥2 isocyanate groups), it is possible to use polyisocyanates to prepare a multitude of polymers (e.g. polyurethanes, polyureas and polyisocyanurates) and low molecular weight compounds (for example urethane prepolymers or those having uretdione, isocyanurate, allophanate, biuret, iminooxadiazinedione and/or oxadiazinetrione structure).

When general reference is made here to “polyisocyanates”, this means monomeric and/or oligomeric polyisocyanates. For understanding of many aspects of the invention, however, it is important to distinguish between monomeric diisocyanates and oligomeric polyisocyanates. When reference is made here to “oligomeric polyisocyanates”, this means polyisocyanates formed from at least two monomeric diisocyanate molecules, i.e. compounds that constitute or contain a reaction product formed from at least two monomeric diisocyanate molecules.

For example, hexamethylene diisocyanate (HDI) is a “monomeric diisocyanate” since it contains two isocyanate groups and is not a reaction product of at least two polyisocyanate molecules:

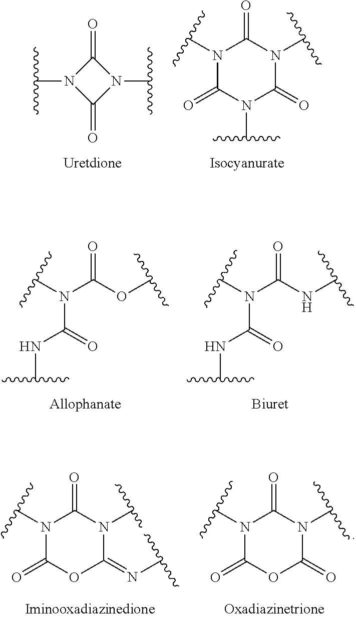

Preparation processes for oligomeric polyisocyanates having uretdione, isocyanurate, allophanate, biuret, iminooxadiazinedione and/or oxadiazinetrione structure for use in accordance with the invention are described, for example, in J. Prakt. Chem. 336 (1994) 185-200, in DE-A 1 670 666, DE-A 1 954 093, DE-A 2 414 413, DE-A 2 452 532, DE-A 2 641 380, DE-A 3 700 209, DE-A 3 900 053 and DE-A 3 928 503 or in EP-A 0 336 205, EP-A 0 339 396 and EP-A 0 798 299.

The catalysts of the present invention are equally well suited for the polymerization of monomeric as well as oligomeric polyisocyanates. However, in some applications the use of oligomeric polyisocyanates has advantages for occupational safety because these are not as volatile as monomeric polyisocyanates. Therefore, in a preferred embodiment, the metals salts of polymeric alcohols are used for the polymerization of oligomeric polyisocyanates.

Results of particular practical relevance are established when the polyisocyanate for use in accordance with the invention has a content of isocyanate groups of 8.0% by weight to 28.0% by weight, preferably of 14.0% to 25.0% by weight, based in each case on the weight of all polyisocyanates used in the polymerization reaction.

Suitable monomeric polyisocyanates which may be used in the polymerization reaction as such or as building blocks for the above-defined oligomeric polyisocyanates are selected from the group consisting of aliphatic, cycloaliphatic, araliphatic and aromatic polyisocyanates. Preferably, the polyisocyanate is an aliphatic or cycloaliphatic monomeric polyisocyanate or an oligomeric polyisocyanate produced by oligomerizing aliphatic or cycloaliphatic diisocyanates.

The term “aliphatic polyisocyanate” refers to all isocyanates having isocyanate groups which are directly bound to a carbon atom which is part of an open chain of carbon atoms.

Preferred aliphatic polyisocyanates are butyldiisocyanate and all isomers thereof, 1,5-diisocyanatopentane (PDI), 1,6-diisocyanatohexane (HDI), 2-methyl-1,5-diisocyanatopentane, 1,5-diisocyanato-2,2-dimethylpentane, 2,2,4- and 2,4,4-trimethyl-1,6-diisocyanatohexane and 1,10-diisocyanatodecane. Particularly preferred are HDI and PDI.

The term “cycloaliphatic polyisocyanate” refers to all isocyanates having isocyanate groups which are directly bound to a carbon atom which is part of a ring structure, provided that said ring structure is not aromatic.

Preferred cycloaliphatic polyisocyanates are 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethyl-cyclohexane (IPDI), 1-isocyanato-1-methyl-4(3)-isocyanatomethylcyclohexane, 2,4′- and 4,4′-diisocyanatodicyclohexylmethane (H12MDI), 1,3- and 1,4-bis(isocyanatomethyl)cyclohexane, bis-(isocyanatomethyl)-norbornane (NBDI), 4,4′-diisocyanato-3,3′-dimethyldicyclohexylmethane, 4,4′-diisocyanato-3,3′,5,5′-tetramethyl-dicyclohexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′,5,5′-tetra-methyl-1,1′-bi(cyclohexyl), 1,8-diisocyanato-p-menthane, 1,3-diisocyanato-adamantane und 1,3-dimethyl-5,7-diisocyanatoadamantane. Particularly preferred is IPDI.

The term “aromatic polyisocyanate” refers to all isocyanates having isocyanate groups which are directly bound to an aromatic ring.

Preferred aromatic polyisocyanates are 2,4- and 2,6-toluene diisocyanate (TDI), 2,4′- and 4,4′-methylene diphenyl diisocyanate (MDI), polymeric 2,4′- and 4,4′-methylene diphenyl diisocyanate (pMDI and 1,5-naphthyl diisocyanate.

The term “araliphatic polyisocyanate” refers to all isocyanates having isocyanate groups which are bound to a methylene group which is in turn is bound to an aromatic ring.

Preferred araliphatic polyisocyanates are 1,3- and 1,4-bis-(isocyanatomethyl)benzene (xylylene diisocyanate; XDI), 1,3- and 1,4-bis(1-isocyanato-1-methyl-ethyl)-benzene (TMXDI) and bis(4-(1-isocyanato-1-methylethyl)phenyl)-carbonate.

### Thermoset Material

The term “thermoset material” refers to the product of the polymerization of polyisocyanates. Said polymerization product has reached the gel point. Preferably it is a solid material. The gel point is defined as the point when storage modulus and loss modulus have the same value, i.e. tan □ is 1. These values can be determined easily by rheological measurements.

As the thermoset material is predominantly formed by addition reactions between isocyanate groups, it only has a limited content of urethane, thiourethane, urea, allophanate and thioallophanate groups. Preferably, less than 30%, more preferably less than 20% and most preferably less than 10% of the total nitrogen content of the thermoset material is bound in urethane, thiourethane, urea, allophanate and thioallophanate groups.

The study underlying the present invention has surprisingly shown that a mixture comprising a metal salt of a polymeric alcohol and a polyisocyanate can be stored for several days at room temperature without polymerizing but nevertheless polymerizes very quickly at elevated temperatures. Thus, according to the present invention the metal salt of a polymeric alcohol is preferably used as a latent catalyst. Said use comprises the preparation of a polymerizable composition as defined below, storing said composition for at least 24 hours at a temperature not higher than 50° C., more preferably not higher than 35° C., before polymerizing the polyisocyanate.

### Polymerizable Composition

In a further embodiment the present invention relates to a polymerizable composition comprising at least one metal salt of a polymeric alcohol and at least one polyisocyanate, wherein the molar ratio of isocyanate groups to functional groups reactive with isocyanate in the composition is at least 2:1.

The metal salt of a polymeric alcohol and the polyisocyanate which are components of the polymerizable composition have been defined above in this application. A polymerizable composition is a composition which comprises said components in amounts which enable the formation of a thermoset material if the polymerizable composition is heated to a sufficient temperature.

In order to limit the formation of urethane, thiourethane, urea, allophanate and thioallophanate groups the concentration of functional groups reactive with isocyanate must be limited. The molar ratio of isocyanate groups to functional groups reactive with isocyanate in the composition is at least 2:1, preferably at least 3:1, more preferably at least 5:1 and most preferably at least 10. 1. “Functional groups reactive with isocyanate” as understood by the present application are thiol groups, hydroxyl groups and amino groups.

Preferably, the concentration of the metal salt of the polymeric alcohol is 0.01 to 15.0 wt.-% based on the amount of the polyisocyanate. If a plurality of polymeric alcohols is used, the concentration refers to the combined concentrations of all polymeric alcohols present.

### Method

In a further embodiment the present invention relates to a method for producing a thermoset polymer comprising the steps of
a) providing a polymerizable composition comprising at least one polyisocyanate and at least one metal salt of a polymeric alcohol, wherein said reaction mixture is characterized by a molar ratio of isocyanate groups to functional groups reactive with isocyanate of at least 2:1;
b) storing said reaction mixture for at least 4 hours at a temperature between 4° C. and 50° C.; and
c) elevating the temperature to a temperature between 60° C. and 300° C. and maintaining said temperature until at least 80% of the free isocyanate groups originally present at the beginning of method step c) are consumed.

Unless specified otherwise, all definitions given above in this application apply to the present embodiment.

The temperature in method step b) is preferably 4° C. to 50° C., more preferably 4° C. to 35° C.

The storage in method step b) last preferably at least 4 hours, more preferably at least 24 hours and most preferably at least 72 hours. It is preferred that the viscosity of the polymerizable composition during storage for the above defined times at the above defined temperatures does not increase by more than 200%, more preferably not more than 100%.

In a preferred embodiment of the present invention at least 50% of the isocyanate groups that are consumed during method step c) form isocyanurate groups.

The following examples are merely intended to illustrate the invention. They shall not limit the scope of the claims in any way.

### EXAMPLES

### Materials and Methods

Poly(ethylene glycol)s (M̅ₙ̅ 0.4, 1, 4 and 10 kg/mol), magnesium di-tert-butoxide, aluminium tri-tert-butoxide, tin(IV) tert-butoxide and tert-butanol were purchased from Sigma-Aldrich. Potassium tert-butoxide was purchased from abcr GmbH. Poly(□-caprolactone) (M̅ₙ̅ 4 and 8 kg/mol) was kindly supplied by Perstorp Chemicals GmbH. Desmodur® N 3600, Desmodur® Z 4470 SN, Desmodur® IL BA, Desmodur® XP 2617 and Desmodur® VPLS 2397 were supplied by Covestro Deutschland AG. All chemicals were used as received.

Differential scanning calorimetry (DSC) measurements were performed under nitrogen on ca. 10 mg samples on a Perkin-Elmer Calorimeter DSC-7 in 3 heating runs from 20 to 200° C. with a heating rate of 20 K/min. and a cooling rate of 320 K/min. FTIR-spectra were recorded on a Bruker FTIR Spectrometer Tensor II with Platinum-ATR-unit with diamond crystal. Viscosities were measured on an Anton-Paar MCR51 Rheometer using a 50 mm cone-plate setup (CP-50) at 23° C. under a shear rate cycle increasing from 0.1 Hz to 1000 Hz and back. In the case of non-Newtonian behavior, the leveled-out viscosity at high shear rate (which at 100 Hz was reached for all cases), was selected.

### 1. Preparation of Tert-Butoxide (Base) Stock-Solutions in Tert-Butanol

1a. Under dry conditions, weighed 2.21 g of anhydrous potassium tert-butoxide (19.7 mmol) into 50 mL Schlenck-flask and added 22.4 g dry tert-butanol. Under continuous stirring, the powder was dissolved (under slight yellowing of the solution). The final concentration of potassium tert-butoxide was then calculated as 2.21 g/(22.4 g+2.21 g)*100%)=8.98 wt %, corresponding to 0.80 mmol tert-butoxide g⁻¹).

1b. In analogy to Example 1a, except that 0.40 g of magnesium di-tert-butoxide was dissolved in 5.45 g tert-butanol (6.8 wt %; 0.80 mmol tert-butoxide g⁻¹).

1c. In analogy to Example 1a, except that 0.45 g of aluminium tri-tert-butoxide was dissolved in 6.37 g tert-butanol (6.6 wt %; 0.80 mmol tert-butoxide g⁻¹).

1d. In analogy to Example 1a, except that 0.70 g of tin(IV) tert-butoxide was added to 7.95 g tert-butanol (8.1 wt %; 0.79 mmol tert-butoxide g⁻¹).

### 2. Deprotonation of Polymeric Alcohols

2a. Under dry conditions, 2.0 g of poly(ethylene glycol) with a number average molecular weight (M̅ₙ̅) of 4000 g mol⁻¹ (corresponding to a total of 1 mmol of OH groups) as the polymeric alcohol and 7.0 g of tert-butanol were added to a 20 mL glass bottle and heated to 90° C. until a homogeneous solution was formed. Next, 1.0 g of potassium tert-butoxide solution from example 1a (corresponding to a total of 0.8 mmol of tert-butoxide) was added at 90° C. as the base, resulting in a homogeneous pale yellow solution. Next, the solution was allowed to cool to room temperature under continuous stirring, under the formation of an opaque thick suspension of fine white powder dispersed in yellow liquid.

2b. In analogy to Example 2a, except that poly(ethylene glycol) with M̅ₙ̅ of 400 g mol⁻¹ was used as the polymeric alcohol and the mixture remained a homogeneous liquid solution upon cooling to room temperature.

2c. In analogy to Example 2a, except that poly(ethylene glycol) with M̅ₙ̅ of 1000 g mol⁻¹ was used as the polymeric alcohol and the mixture remained a homogeneous liquid solution upon cooling to room temperature.

2d. In analogy to Example 2a, except that poly(ethylene glycol) with M̅ₙ̅ of 10000 g mol⁻¹ was used as the polymeric alcohol.

2e. In analogy to Example 2a, except that poly(propylene glycol) with M̅ₙ̅ of 1000 g mol⁻¹ was used as the polymeric alcohol and the mixture remained a homogeneous liquid solution upon cooling to room temperature.

2f. In analogy to Example 2a, except that poly(propylene glycol) with M̅ₙ̅ of 2000 g mol⁻¹ was used as the polymeric alcohol and the mixture remained a homogeneous liquid solution upon cooling to room temperature.

2g. In analogy to Example 2a, except that poly(propylene glycol) with M̅ₙ̅ of 4000 g mol⁻¹ was used as the polymeric alcohol and the mixture remained a homogeneous liquid solution upon cooling to room temperature.

2h. In analogy to Example 2a, except that polytetrahydrofuran with M̅ₙ̅ of 650 g mol⁻¹ was used as the polymeric alcohol.

2i. In analogy to Example 2a, except that polytetrahydrofuran with M̅ₙ̅ of 1000 g mol⁻¹ was used as the polymeric alcohol.

2j. In analogy to Example 2a, except that polytetrahydrofuran with M̅ₙ̅ of 2000 g mol⁻¹ was used as the polymeric alcohol.

2k. In analogy to Example 2a, except that polycaprolactone with M̅ₙ̅ of 4000 g mol⁻¹ was used as the polymeric alcohol.

2l. In analogy to Example 2a, except that polycaprolactone with M̅ₙ̅ of 8000 g mol⁻¹ was used as the polymeric alcohol.

2m. In analogy to Example 2a, except that the magnesium tert-butoxide solution of example 1b was used as the base.

2n. In analogy to Example 2a, except that the aluminium(III) tert-butoxide solution of example 1c was used as the base.

2o. In analogy to Example 2a, except that the tin(IV) tert-butoxide solution of example 1d was used as the base.

### 3. Polymerization Reactions of Polyisocyanates Using Thermolatent Polymeric Alkoxide Catalyst Systems

3a. 10.0 g of Desmodur® N3600 was weighed into a dried 20 mL glass bottle as the polyisocyanate, after which 0.35 g of the reaction mixture from example 2a was added as the polymeric alkoxide catalyst system. The mixture was then shaken vigorously by hand until a macroscopically homogeneous mixture was formed. No apparent heat formation or gelation was observed during mixing.

Next, 5 g of the reaction mixture was casted into an aluminium tin can lid, while another 5 g of the reaction mixture was transferred into a 20 mL glass bottle which was then sealed under a dry nitrogen atmosphere. The sample in the aluminium lid (denoted Sample A) was subsequently kept at 220° C. for 5 minutes while the sample in the glass bottle (denoted Sample B) was kept at room temperature for 24h. After these reaction times, Sample A was collected as a partially blistered solid transparent yellow film while Sample B remained liquid throughout the reaction time. Sample A was analyzed using Attenuated Total Reflection Fourier-Transformed Infrared Spectroscopy (ATR-FTIR). Sample B was analyzed visually by inverting the bottle and confirming a free flow of the mixture.

3b. In analogy to example 3a, except that the reaction mixture of example 2b was used as the polymeric alkoxide catalyst system.

3c. In analogy to example 3a, except that the reaction mixture of example 2c was used as the polymeric alkoxide catalyst system.

3d. In analogy to example 3a, except that the reaction mixture of example 2d was used as the polymeric alkoxide catalyst system.

3e. In analogy to example 3a, except that the reaction mixture of example 2e was used as the polymeric alkoxide catalyst system.

3f. In analogy to example 3a, except that the reaction mixture of example 2f was used as the polymeric alkoxide catalyst system.

3g. In analogy to example 3a, except that the reaction mixture of example 2g was used as the polymeric alkoxide catalyst system.

3h. In analogy to example 3a, except that the reaction mixture of example 2h was used as the polymeric alkoxide catalyst system.

3i. In analogy to example 3a, except that the reaction mixture of example 2i was used as the polymeric alkoxide catalyst system.

3j. In analogy to example 3a, except that the reaction mixture of example 2j was used as the polymeric alkoxide catalyst system.

3k. In analogy to example 3a, except that the reaction mixture of example 2k was used as the polymeric alkoxide catalyst system.

3l. In analogy to example 3a, except that the reaction mixture of example 2l was used as the polymeric alkoxide catalyst system.

3m. In analogy to example 3a, except that the reaction mixture of example 2m was used as the polymeric alkoxide catalyst system.

3n. In analogy to example 3a, except that the reaction mixture of example 2n was used as the polymeric alkoxide catalyst system.

3o. In analogy to example 3a, except that the reaction mixture of example 2o was used as the polymeric alkoxide catalyst system.

3p. In analogy to example 3a, except that Desmodur® Z 4470 SN was used as the polyisocyanate.

3q. In analogy to example 3a, except that Desmodur® IL BA was used as the polyisocyanate.

3r. In analogy to example 3a, except that Desmodur® XP 2617 was used as the polyisocyanate.

3s. In analogy to example 3a, except that Desmodur® VPLS 2397 was used as the polyisocyanate.

### 4. Quantification of the Reactivity of a Polyisocyanate Mixture Containing a Thermolatent Polymeric Alkoxide Catalyst System

In analogy to example 3a, a mixture was prepared using Desmodur® N 3600 as the polyisocyanate and the reaction mixture of example 2a as the thermolatent polymeric alkoxide catalyst system. The reactivity of the reaction mixture was then measured using Differential Scanning Calorimetry (DSC).

### 5. Quantification and Monitoring Over Time of the Viscosity of a Polyisocyanate Mixture Containing a Thermolatent Polymeric Alkoxide Catalyst System

In analogy to example 3a, a mixture was prepared using Desmodur® N 3600 as the polyisocyanate and the reaction mixture of example 2a as the thermolatent polymeric alkoxide catalyst system. The viscosities of the neat Desmodur® N 3600 and of the reaction mixture at the specified times after the addition of the polymeric alkoxide catalyst system were measured on an Anton-Paar MCR51 Rheometer using a 25 mm cone-plate setup. The results are collected in Table 1.

TABLE 1
Viscosities of Polyisocyanate mixtures.

| Mixture | Viscosity at a shear rate of 100 Hz |
|---|---|
| Desmodur ® N 3600 (neat) | 1430 mPa · s |
| Reaction Mixture, day 0 | 1170 mPa · s |
| Reaction Mixture, day 7 | 1270 mPa · s |

### 5. Overview (Table) of Experimental Results

TABLE 2
Overview of experimental results. time_{liquid} shows the time the reaction
mixture remained liquid at room temperature. T_{reaction} and time_{reaction}
show the curing reaction temperature and time, respectively.

| | Poly- | | | | | | |
|---|---|---|---|---|---|---|---|
| Exp. | isocyanate | | | time_{liquid} | T_{reaction} | time_{reaction} | Reaction |
| Nr. | (Desmodur) | Alkoxide | Cation | [days] | [° C.] | [min] | product |
| 3a | N3600 | PEG-4k | K⁺ | >7 | 220 | 5 | Solid; |
| | | | | | | | w/slight |
| | | | | | | | yellowing |
| 3b | N3600 | PEG-0.4k | K⁺ | >7 | 220 | 5 | Solid |
| 3c | N3600 | PEG-1k | K⁺ | <7 | 220 | 5 | Solid |
| 3d | N3600 | PEG-10k | K⁺ | >7 | 220 | 5 | Solid |
| 3e | N3600 | PPG-1k | K⁺ | >7 | 220 | 5 | Solid |
| 3f | N3600 | PPG-2k | K⁺ | >7 | 220 | 5 | Solid |
| 3g | N3600 | PPG-4k | K⁺ | >7 | 220 | 5 | Solid |
| 3h | N3600 | PTHF-0.65k | K⁺ | >7 | 220 | 5 | Solid |
| 3i | N3600 | PTHF-1k | K⁺ | >7 | 220 | 5 | Solid |
| 3j | N3600 | PTHF-2k | K⁺ | >7 | 220 | 5 | Solid |
| 3k | N3600 | PCL-4k | K⁺ | >7 | 220 | 5 | Solid |
| 3l | N3600 | PCL-8k | K⁺ | >7 | nd | nd | nd |
| 3m | N3600 | PEG-4k | Mg²⁺ | >7 | nd | nd | nd |
| 3n | N3600 | PEG-4k | Al³⁺ | >7 | nd | nd | nd |
| 3o | N3600 | PEG-4k | Sn⁴⁺ | >7 | nd | nd | nd |
| 3p | Z 4470 SN | PEG-4k | K⁺ | >7 | nd | nd | nd |
| 3q | IL BA | PEG-4k | K⁺ | >7 | nd | nd | nd |
| 3r | XP 2617 | PEG-4k | K⁺ | >7 | nd | nd | nd |
| 3s | VPLS 2397 | PEG-4k | K⁺ | >7 | nd | nd | nd |
| Ref. 1 | N3600 | MeO⁻ | K⁺ | nd | nd | nd | nd |
| Ref. 2 | N3600 | tBuO⁻ | K⁺ | nd | nd | nd | nd |

nd: not determined

1. Use of a metal salt of a polymeric alcohol as a catalyst for the polymerization of polyisocyanates.

2. The use according to claim 1, wherein the polymeric alcohol has a number average molecular weight between 400 g/mol and 22,000 g/mol.

3. The use according to claim 1, wherein the polymeric alcohol has a melting point between 25° C. and 160° C.

4. The use according to claim 1, wherein the polymeric alcohol is an alcohol selected from the group consisting of polyether alcohols, polyester alcohols and polycarbonate alcohols.

5. The use according to claim 1, wherein the metal ion has an oxidation state IV or less.

6. The use according to claim 1, wherein crosslinking of polyisocyanates results in at least one functional group selected from the group consisting of isocyanurate, uretdione, iminooxadiazinedione and oxadiazinetrione groups.

7. The use according to claim 1, wherein the polyisocyanates are selected from the group consisting of aliphatic, cycloaliphatic and aromatic polyisocyanates.

8. The use according to claim 1, wherein at least 50% of the isocyanate groups consumed during the polymerization of isocyanates form isocyanurate structures.

9. The use according to claim 1, wherein less than 30% of the total nitrogen content of the thermoset material is bound in urethane, thiourethane, urea, allophanate and thioallophanate groups.

10. A method for producing a thermoset polymer comprising the steps of
a) providing a polymerizable composition comprising at least one polyisocyanate and at least one metal salt of a polymeric alcohol, wherein said reaction mixture is characterized by comprises a molar ratio of isocyanate groups to functional groups reactive with isocyanate in the composition is at least 2:1
b) storing said reaction mixture for at least 4 hours at a temperature between 4° C. and 50° C. without an increase of viscosity of more than 100%; and
c) elevating the temperature to a temperature between 60° C. and 300° C. and maintaining said temperature until at least 80% of the free isocyanate groups originally present at the beginning of method step c) are consumed.

11. The method according to claim 10, wherein the polymeric alcohol is an alcohol selected from the group consisting of polyether alcohols, polyester alcohols, polycarbonate alcohols.

12. The method according to claim 10, wherein at least 50% of the isocyanate groups consumed during method step c) form isocyanurate groups.

13. A polymerizable composition comprising at least one metal salt of a polymeric alcohol and at least one polyisocyanate, wherein the molar ratio of isocyanate groups to functional groups reactive with isocyanate in the composition is at least 2:1.
